(19) United States
(12) Patent Application Publication
(10) Pub. No.: US 2002/0125053 A1
(43) Pub. Date: Sep. 12, 2002

(54) Electric vechicle control and propulsion system

(76) Inventor: Robert O. Judkins, Greenview, CA (US)

Correspondence Address: Andrew K. Youngs, 6723A 32nd Street, North Highlands, CA, 95660, US

(21) Appl. No.: 09/802,045

(22) Filed: Mar. 7, 2001

(51) Int. Cl. B60K 1/00

(52) U.S. Cl. 180/65.6; 180/65.1

(57) ABSTRACT

Vehicles powered by electric motors have required complex control mechanisms and electronics to ensure proper power is supplied to drive wheels. These mechanisms add greatly to the cost, complexity and weight of electric vehicles, reducing their viability.

This novel method comprises the use of a continuously variable transmission (CVT) as the throttle element, interacting with an electric drive motor, most notably a direct current permanent magnet motor (DCPM). External control of the drive ratio of the CVT provides for torque and power adjustments by varying the output ratio of the CVT. The inherent speed versus torque characteristics of the DCPM allow for control of vehicle speed and acceleration simply by the varying of the output ratio of the CVT.

### BACKGROUND OF THE INVENTION

Electrically propulsed vehicles have become an area of considerable interest in the last several years, due to the reduced pollution capabilities of such vehicular systems. Many states have considered or passed legislation which will require the substantial use of alternatively fueled vehicles, of which electrically propulsed is a leading candidate, in the near future.

A number of patents detail design and control of hybrid vehicles which use both electric motors and/or generators, in addition to an internal combustion engine. Yamaguchi (U.S. Pat. Nos. 5,899,286 and 5,806,617) teaches hybrid vehicles wherein the electric motor is connected to a generator, and controlled to supplement the propulsion of the internal combustion engine. Ibakari, et.al. (U.S. Pat. Nos. 5,722,911 and 5,927,415) claims a drive control apparatus for a hybrid vehicle of the type described by Yamaguchi, wherein the electric motor power is used to allow the internal combustion engine to operate at an efficient steady-state condition.

Kiuchi, et. al. (U.S. Pat. No. 5,621,304) provides for an electric vehicle wherein power for the motor is supplied by an internal combustion engine driving a generator, in which the power to the motor, and therefore its output, is controlled by adjusting the throttle settings and air intake openings of the internal combustion engine.

The use of continuously variable transmissions to drive vehicles is described by Pels (U.S. Pat. No. 6,167,339) for use in hybrid vehicles with two or more power sources, most notably an internal combustion engine coupled with an electric motor/generator combination. Pels uses the CVT to allow the internal combustion engine to operate at its most efficient area, while using the secondary power sources for supplemental power. The design and construction of CVTs are well known to those skilled in the art.

Yamamoto, et. al., describe the use of two CVTs in a hybrid vehicle, one connected to the output shaft of an internal combustion engine, and the other driving a generator/motor and pulleys for secondary units such as air conditioning compressors, power-steering units, etc. Yammamoto's use of the CVT is to allow the motor/generator to operate at peak efficiency, regardless of the output rpm of the internal combustion engine.

A number of patents describe means for controlling electric vehicles, wherein the sole source of power is an electric motor. Tsuzuki, et. al., (U.S. Pat. No. 5,903,061) describes a control apparatus utilizing planetary gears, which is controlled via a complex array of sensor inputs to allow maximization of motor efficiency. Chen, et. al. (U.S. Pat. No. 5,473,725), White (U.S. Pat. No. 4,240,015), Lecluse (U.S. Pat. No. 4,191,914), Santini (U.S. Pat. No. 4,399,393), Post (U.S. Pat. No. 4,389,602), Cvetnic (U.S. Pat. No. 3,826.958) and Krueger, et.al. (U.S. Pat. No. 4,675,585) all describe relatively complex electrical circuits utilized to provide throttling and control of electric motors utilized for powering vehicles.

Use of a CVT to assist in controlling the speed of a vehicle is described by Gray (U.S. Pat. No. 5,495,912) and Waddington (U.S. Pat. No. 4,256,196). Gray adjusts the input speed of the motor driving the CVT in a hybrid vehicle. When excess power is supplied by the internal combustion engine, it is stored in a fluid accumulator. Power thus stored can be used when demand exceeds engine capability. Gray requires the use of a CPU and engine speed controller.

Waddington describes a form of CVT utilizing adjustable cams, which is utilized in an electrically propelled vehicle. Waddington requires the electric motor to be a constant speed motor, mandating that no-load to full-load speed variation be less than ten percent.

### BRIEF SUMMARY OF THE INVENTION

This invention comprises the use of an output ratio controlled continuously variable transmission (CVT) driven by a motor, such as a direct current permanent magnet (DCPM) motor, to propel a vehicle such as an automobile. The input to output rpm ratio of the CVT is adjusted in response to a simple mechanism, such as an accelerator pedal, to control the speed of the vehicle. The DCPM motor thus draws current as needed to meet the torque requirements placed on it by the CVT, allowing for smooth acceleration and optimized energy efficiency. During deceleration, there is an inherent regenerative braking effect, wherein the motor can act as a generator to recharge the electrical power source.

According to the present invention, these objects are achieved by utilizing a continuously variable transmission which can be externally controlled as to drive ratio. Speed increases or decreases are made by selecting the appropriate transmission drive ratio. By utilizing a continuously variable transmission, as opposed to one with discrete drive ratios, acceleration and deceleration are performed very smoothly. If an increase in power is needed while maintaining constant speed, such as in the case of an incline or a headwind, speed is maintained by an appropriate decrease in the transmission drive ratio.

According to the present invention, an advantage of this system, in addition to the ability to utilize motors with a broad range of no-load to full-load speed ratios, is that the drive and control mechanisms can be constructed with relative simplicity, low cost, low volume requirements, and low weight. Thus an electric vehicle utilizing this invention can be produced inexpensively while maintaining excellent energy efficiency and reliability.

A further aspect to this invention is that it is applicable to both an all-electric vehicle, powered by a battery source, or to a hybrid vehicle, wherein the electrical power to drive the DCPM motor is derived from an engine or fuel cell.

### BRIEF DESCRIPTION OF THE FIGURES

FIG. 1 shows a schematic overview of the basic propulsion system, including DC power source 1, switch 2, DC motor 3, transmission ratio controller 4, continuously variable transmission 6, vehicle wheel 6 and drive train 7.

FIG. 2 is a graph illustrating the characteristic torque and speed response for a nominal five horsepower DCPM motor.

FIG. 3 is a graph illustrating the expected vehicle speed versus horsepower requirements for a 2250-pound vehicle with frontal area of fifteen square feet, aerodynamic drag coefficient of 0.35, and mechanical drag coefficient of 0.016.

FIG. 4 is a graph illustrating the expected transmission ratio required for desired level road speed assuming the factors of the table in FIG. 5.

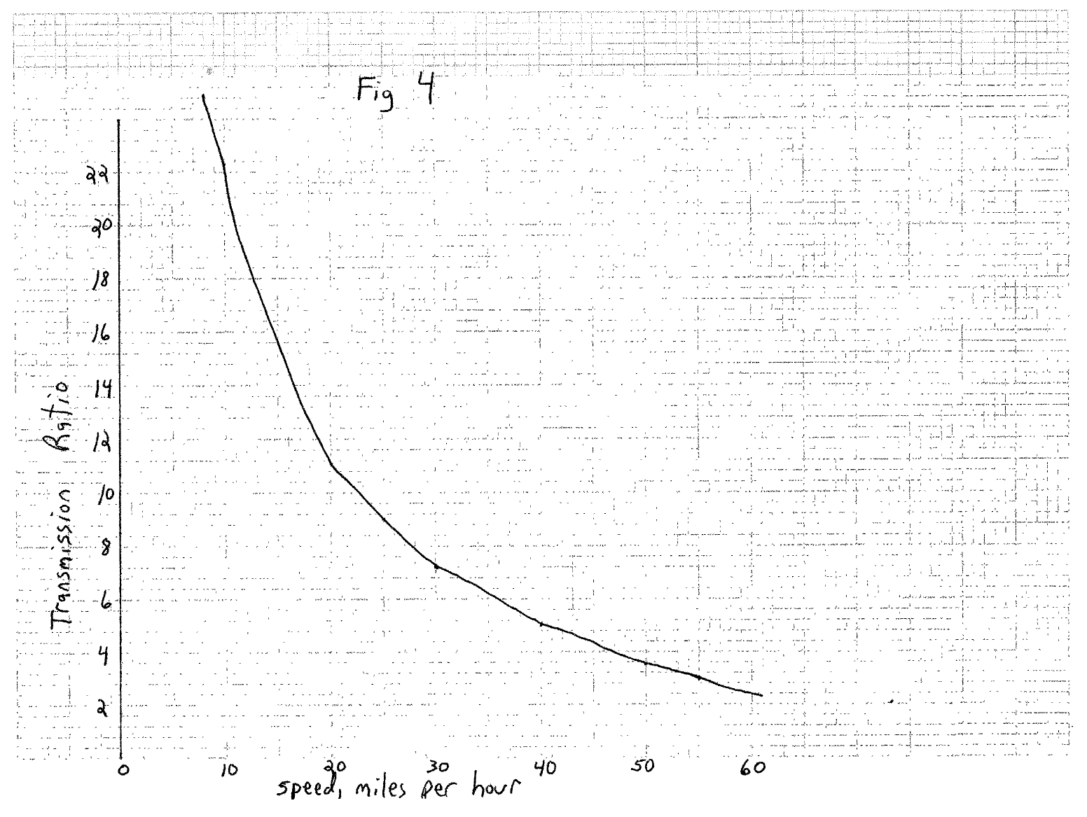

FIG. 5 is a table detailing the expected level road speed, horsepower requirements, motor rpm, wheel rpm and transmission ratio for the vehicle as detailed in FIG. 3, assuming an R13 wheel with an outside diameter of 23 inches.

### DETAILED DESCRIPTION OF THE INVENTION

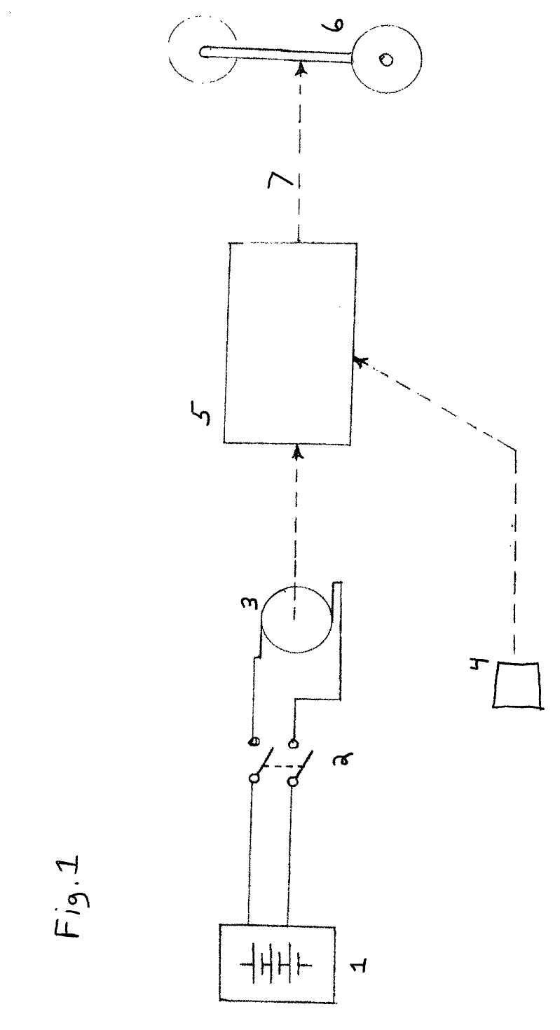

Referring now to FIG. 1, this invention comprises a vehicle propulsion system comprising an electric motor 3 which is connected to electrical power source 1 through switch 2. The output shaft from motor 3 is coupled to a continuously variable transmission (CVT) 5, with the output shaft of CVT 5 coupled through drivetrain 7 to vehicle drive wheels 6. The ratio of input revolutions per minute (rpm) of CVT 5 to output rpm is continuously variable, and is adjusted based on input from transmission ratio control 4.

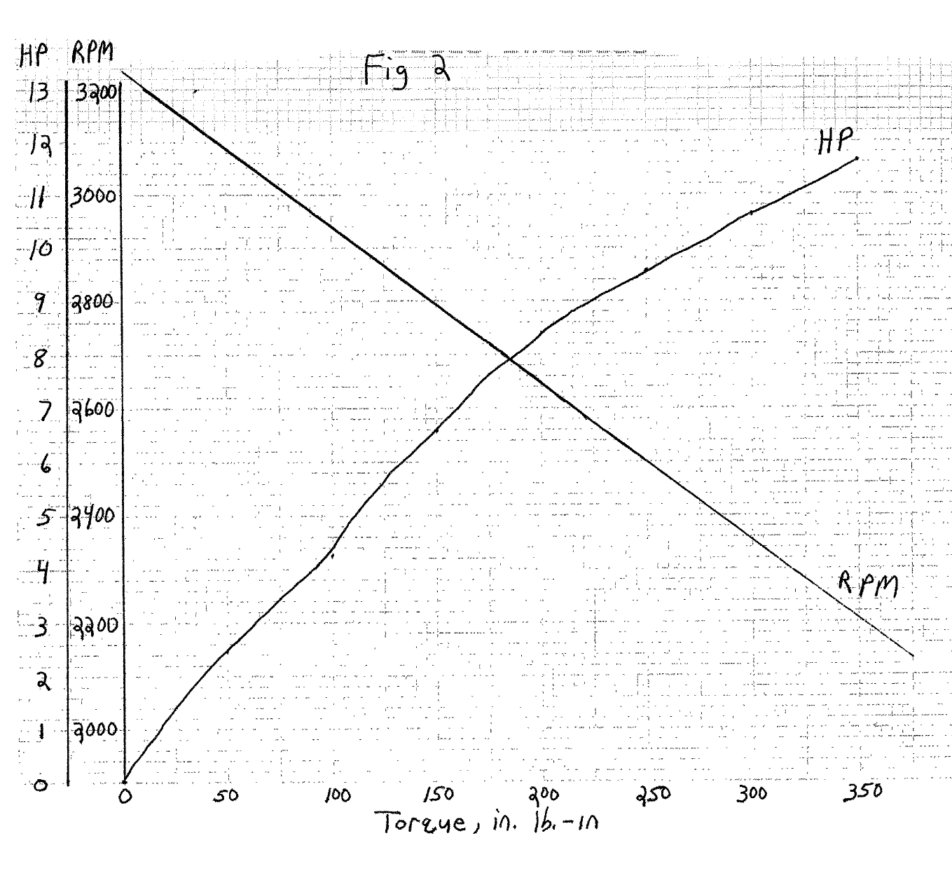

In one preferred embodiment of this invention, the motor 3 is a direct current permanent magnet (DCPM) electric motor. Referring now to FIG. 2, DCPM motors have a characteristic torque versus speed response which is illustrated therein. DCPM motors provide higher levels of torque at lower rpm, but power capability as measured by horsepower, increase with increasing rpm. Thus the rpm of the DCPM motor will self-regulate based on the torque and power demands placed on it.

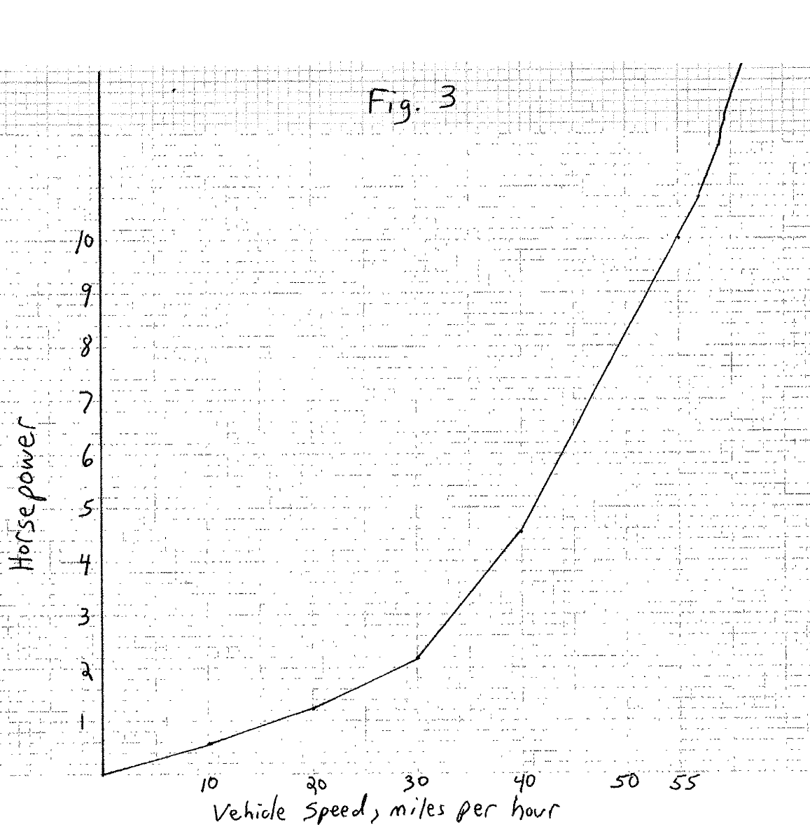

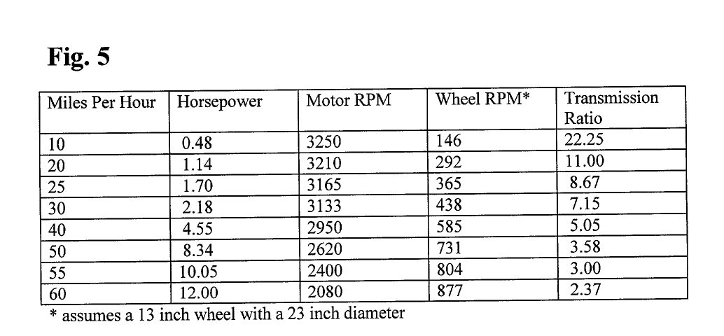

When motor 3 is a DCPM motor, speed of the vehicle can be smoothly and continuously changed by adjusting the input to output ratio of CVT 5. Increasing the speed of the vehicle requires more power, as illustrated in FIG. 3, to overcome rolling resistance and aerodynamic drag. FIG. 5 details in table form the expected horsepower requirements, motor rpm, wheel rpm and transmission ratio requirements for a 2250 pound vehicle with a frontal area of fifteen square feet, an aerodynamic drag coefficient of 0.35, a mechanical drag coefficient of 0.016, and wheels with an outside diameter of 23 inches.

At constant speed, changes in power needs due to inclines or increase headwinds are met by an appropriate transmission ratio decrease, thereby dictating increased motor torque and power automatically. Decreases in power needs due to a decline in grade or a tailwind will be met by increasing transmission ratio, decreasing motor torque and power automatically.

Regenerative braking, in which the motor is revolved by the force of the turning wheels, is inherent in this system. The motor in these instances becomes a generator, sending current back to the power source for storage and later use.

The design and construction of CVTs are well known in the art, and CVTs can be easily controlled by simple mechanical means such as a spring-loaded throttle or a throttle cable. As the DCPM motor regulates itself as to current draw and power in this system, expensive and complex electrical control systems are not required. This allows for production of electrically powered and/or hybrid vehicles which are inexpensive, light weight and energy efficient.

The current invention provides a means of propelling and controlling the speed of an electric or hybrid vehicle, and can be utilized in a number of areas and devices, not just those shown and described:

I claim:

1. A vehicle propulsion system comprising:
a motor;
means for providing power for said motor;
drive wheels;
a continuously variable transmission (CVT) with an input shaft coupled to the motor and an output shaft;
means for transferring the rotation of the output shaft of the CVT to the drive wheels;
means for adjusting the input to output ratio of the CVT;
wherein the speed of the vehicle so propulsed is adjusted by changing the input to output ratio of the CVT.

2. The vehicle propulsion system according to claim 1 in which the motor is a direct current permanent magnet motor.

3. The vehicle propulsion system of claim 2, wherein the motor has a no-load to full-load speed variance of greater than ten percent.

4. The vehicle propulsion system of claim 1, wherein the means to adjust CVT input to output ratios is controlled by a simple mechanical throttle device.
